(19) United States
(12) Patent Application Publication
(10) Pub. No.: US 2020/0247335 A1
(43) Pub. Date: Aug. 6, 2020

(54) ROTARY CONNECTOR

(71) Applicant: KABUSHIKI KAISHA TOKAI RIKA DENKI SEISAKUSHO, Aichi (JP)

(72) Inventor: Seiji KONDO, Aichi (JP)

(73) Assignee: KABUSHIKI KAISHA TOKAI RIKA DENKI SEISAKUSHO, Aichi (JP)

(21) Appl. No.: 16/316,187

(22) PCT Filed: Jun. 26, 2017
(86) PCT No.: PCT/JP2017/023457

§ 371 Date: Jan. 8, 2019

(30) Foreign Application Priority Data
Jul. 11, 2016 (JP) 2016-136908

(51) Int. Cl. B60R 16/027; H04B 10/07

(52) U.S. Cl. CPC B60R 16/027; H04B 10/07

(57) ABSTRACT

A rotary connector includes a fixed body and a rotary body. One of the fixed body and the rotary body includes a plurality of light emitting elements, and the other of the fixed body and the rotary body includes a light receiving element. The rotary connector allows optical communication between the light emitting elements and the light receiving element to allow communication between the fixed body and the rotary body when rotation of the rotary body is allowed. The rotary connector further includes a speed determination unit that determines a rotation speed of the rotary body and an element selection unit that selects a light emitting element that is activated from the light emitting elements based on a determination result of the speed determination unit.

### TECHNICAL FIELD

The present invention relates to a rotary connector that improves communication between a fixed body and a rotary body.

### BACKGROUND ART

A typical steering roll connector is a widely known rotary connector that maintains electrical connection between two components, one of which rotates relative to the other. A known steering roll connector of this type, for example, transmits communication data from a rotary body to a fixed body through optical communication in a contactless manner (refer to patent document 1).

### PRIOR ART DOCUMENT

### Patent Document

Patent Document 1: Japanese Laid-Open Patent Publication No. 59-188799

### SUMMARY OF THE INVENTION

### Problems that are to be Solved by the Invention

Patent document 1 describes a technique that continuously and simultaneously activates multiple light emitting elements. Thus, large current consumption adversely affects power saving.

It is an object of the present invention to provide a rotary connector that reduces power consumption to improve power saving.

### Means for Solving the Problem

An aspect of a rotary connector includes a fixed body and a rotary body. One of the fixed body and the rotary body includes light emitting elements, and the other of the fixed body and the rotary body includes a light receiving element. The rotary connector allows optical communication between the light emitting elements and the light receiving element to allow communication between the fixed body and the rotary body when rotation of the rotary body is allowed. The rotary connector includes a speed determination unit that determines a rotation speed of the rotary body and an element selection unit that selects a light emitting element that is activated from the light emitting elements based on a determination result of the speed determination unit.

With this configuration, when communication is performed between the fixed body and the rotary body through optical communication using the light emitting elements and the light receiving element, the rotation speed of the rotary body is obtained, and the light emitting elements are activated at points in time corresponding to the rotation speed of the rotary body. Thus, all of the light emitting elements are not constantly activated during optical communication. Instead, appropriate ones from the light emitting elements are selected in accordance with the rotation speed of the rotary body. This reduces power consumption and improves power saving.

Preferably, the rotary connector includes an angle determination unit that determines a rotation angle of the rotary body. The element selection unit uses the rotation speed and the rotation angle as parameters to select the light emitting element that is activated. With this configuration, the light emitting element is activated at the optimal point in time in accordance with the condition. This is advantageous to improve the stability of communication establishment.

Preferably, in the rotary connector, the rotation angle is an angle of the light emitting element in a rotation direction of the rotary body, and the element selection unit activates the light emitting element at a point in time when the rotation angle reaches an activation start point. The element selection unit changes the activation start point in accordance with the rotation speed to change a point in time for activating the light emitting element. With this configuration, the activation of the light emitting element is optimized through a simple process that changes the activation start point of the light emitting element in accordance with the rotation speed of the rotary body. This is further advantageous to increase the stability of communication establishment.

Preferably, in the rotary connector, a range in a rotation direction of the rotary body where the light emitting element is activated is sets as an activation range. The element selection unit sets the activation range to be wider as the rotation speed increases and sets the activation range to be narrower as the rotation speed decreases. With this configuration, as the rotation speed of the rotary body increases, the activation range of the light emitting element is set to be wider, accordingly. Thus, even when the rotary body rotates quickly, light from the light emitting element consistently strikes the light receiving element.

Preferably, in the rotary connector, a maximum number of the light emitting elements that are simultaneously activated is two. With this configuration, power saving is improved as compared to when all of the light emitting elements are constantly activated.

### Effect of the Invention

According to the present invention, power consumption is reduced to improve power saving.

### BRIEF DESCRIPTION OF THE DRAWINGS

FIG. 1 is a perspective view illustrating a structure of an embodiment of a rotary connector.

FIG. 2 is a diagram illustrating an electrical configuration of a rotary connector.

FIG. 3 is a diagram illustrating the relationship between binary communication data and light irradiation timings.

FIG. 4A is a plan view of a rotary connector illustrating a point in time for activating a light emitting element at a low rotation speed.

FIG. 4B is a side view of the rotary connector illustrating a point in time for activating a light emitting element at the low rotation speed.

FIG. 5 is a diagram illustrating changes in an activation start point of a light emitting element.

FIG. 6A is a plan view of a rotary connector illustrating a point in time for activating light emitting elements at a high rotation speed.

FIG. 6B is a side view of the rotary connector illustrating a point in time for activating light emitting element at the high rotation speed.

### EMBODIMENTS OF THE INVENTION

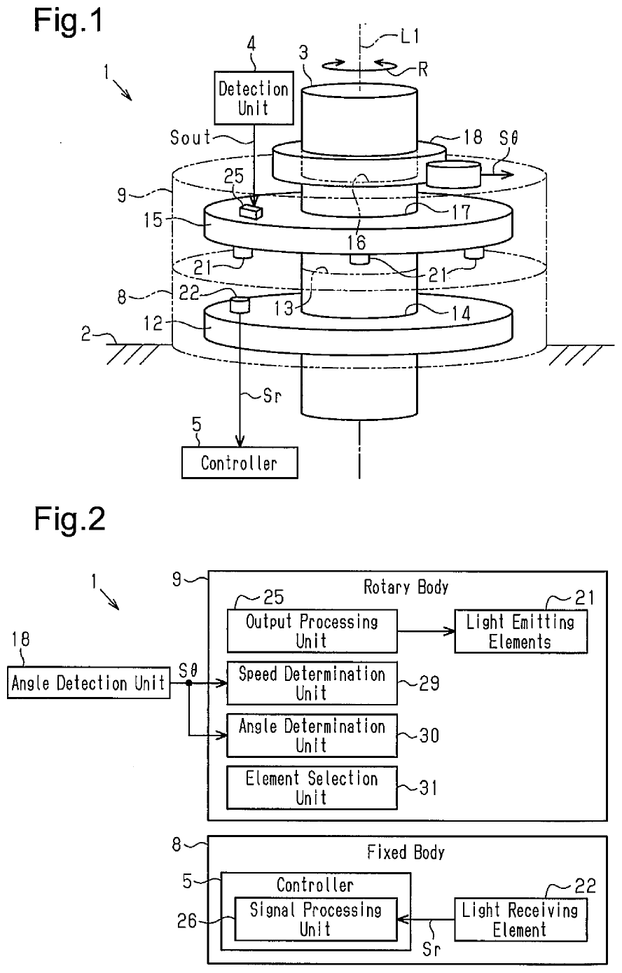

An embodiment of a rotary connector will now be described with reference to FIGS. 1 to 6B.

As illustrated in FIG. 1, a rotary connector 1 for a vehicle is coupled between a vehicle body 2 corresponding to a fixed side and a steering shaft 3 corresponding to a rotary side. The rotary connector 1 allows contactless communication between the vehicle body 2 and the steering shaft 3 and maintains the communication between these two even when the steering shaft 3 is rotated. The rotary connector 1 transmits an output signal Sout of a detection unit 4 arranged on a steering wheel (not illustrated) to a controller 5 located toward the vehicle body 2. The controller 5 includes an electronic control unit (ECU) controlling actuation of the rotary connector 1 and determines a detection state of the detection unit 4 based on the output signal Sout.

The detection unit 4 includes, for example, a switch or a sensor arranged on the steering wheel. The output signal Sout is not limited to, for example, an on-off signal detected by a switch or a sensor, and may be, for example, a data signal detected by a sensor such as an image sensor.

The rotary connector 1 includes a fixed body 8 coupled and fixed to the vehicle body 2 and a rotary body 9 rotating relative to the fixed body 8. The fixed body 8 and the rotary body 9 are discoid and coaxial with each other (axis L1). The axis L1 is the axis of the steering shaft 3.

The fixed body 8 includes a substrate 12 on which electrical components used at the side of the fixed body 8 are mounted. The steering shaft 3 is rotationally inserted through insertion holes 13 and 14 respectively extending through the center of the fixed body 8 and the substrate 12. The rotary body 9 includes a substrate 15 on which electrical components used at the side of the rotary body 9 are mounted. The steering shaft 3 is inserted through insertion holes 16 and 17 respectively extending through the center of the rotary body 9 and the substrate 15, and they are configured to integrally rotate. When the steering shaft 3 is rotated, the rotary body 9 is supported by the fixed body 8 and rotates integrally with the steering shaft 3 about the axis L1 (in direction of arrow R in FIG. 1).

The vehicle includes an angle detection unit 18 that detects an angle when the rotary body 9 is rotated. The angle detection unit 18 includes, for example, an optical sensor or a magnetic sensor, and is configured to detect the angle of the rotary body 9 in a range of 0° to 360°. The angle detection unit 18 detects an angle detection signal Sθ and transmits the angle detection signal Sθ to the controller 5 or an IC of the rotary body 9.

The rotary connector 1 uses a communication system of an optical communication type in which signals are transmitted between the fixed body 8 and the rotary body 9 and received by its peer through presence and absence of light. In this example of a communication system of an optical communication type, the output signal Sout from the detection unit 4 located at the steering wheel side is wirelessly transmitted through optical communication from the rotary body 9 toward the fixed body 8 as communication data Sd. The communication data Sd obtains binarized information including a data group of zero and one based on a combination of “presence” and “absence” of light. It is preferred that the communication data Sd be a multiplexing signal, in which signals output from multiple detection units 4 are together transmitted to a peer through time-division. Optical communication allows the communication data Sd to be transmitted to a peer at a high speed (high-speed communication).

The rotary connector 1 includes light emitting elements 21 that emit light during optical communication and a light receiving element 22 that receives the light from the light emitting elements 21. The light emitting elements 21 are attached to a rear surface of the substrate 15 at equal intervals about the axis L1 of the rotary body 9. It is preferred that the light emitting elements 21 be, for example, light emitting diodes (LEDs). The multiple light emitting elements 21 are arranged so that the light from the light emitting elements 21 reaches the light receiving element 22 at any rotational angle of the rotary body 9. The light receiving element 22 is attached to a front surface of the substrate 12 on a position opposed to a movement path K (movement track) of the light emitting elements 21 (refer to FIGS. 4A, 4B, 6A, and 6B) when the rotary body 9 rotates.

As illustrated in FIG. 2, the rotary connector 1 includes an output processing unit 25 that controls actuation of the light emitting elements 21. The output processing unit 25 is arranged on the rotary body 9 and is preferably, for example, an IC mounted on the substrate 15. The output processing unit 25 switches between processes that activate and deactivate the light emitting elements 21 (turning on/off of light) to generate a light emitting pattern from the light emitting elements 21 corresponding to binary information of the communication data Sd and allow the light receiving element 22 to receive the light having the light emitting pattern.

The rotary connector 1 includes a signal processing unit 26 that obtains the communication data Sd from the transmitting side (in the present example, output signal Sout of detection unit 4) based on a light receiving signal Sr of the light receiving element 22. The controller 5 includes the signal processing unit 26. The signal processing unit 26 determines data contents of the communication data Sd based on the light receiving signal Sr received from the light receiving element 22 and performs operation in accordance with the communication data Sd.

The rotary connector 1 has an element activation selectins function that selects only a portion of the light emitting elements 21 in accordance with a rotation speed V of the rotary body 9 from the light emitting elements 21 and activates the selected light emitting elements 21. If all of the light emitting elements 21 are constantly activated, power for activating the light emitting elements 21 is increased, and power saving will not be improved. The element activation selection function of the present example improves power saving by selectively activating the light emitting elements 21.

The rotary connector 1 includes a speed determination unit 29 that determines the rotation speed V of the rotary body 9. The speed determination unit 29 is included in the rotary body 9 (IC of rotary body 9) and determines the rotation speed V of the rotary body 9 based on the angle detection signal Sθ received from the angle detection unit 18.

The rotary connector 1 includes an angle determination unit 30 that determines a rotational angle θ of the rotary body 9. The angle determination unit 30 is included in the rotary body 9 (IC of rotary body 9) and determines the rotational angle θ (rotational position) of the rotary body 9 based on the angle detection signal Sθ received from the angle detection unit 18. It is preferred that the angle determination unit 30 detect the rotational angle θ of the rotary body 9, for example, at a few degrees of resolution.

The rotary connector 1 includes an element selection unit 31 that selects ones that are activated from the light emitting elements 21 based on the determination result of the speed determination unit 29. The element selection unit 31 is included in the rotary body 9 (IC of rotary body 9) and selects one(s) that are activated from the light emitting elements 21 based on the determination result of the speed determination unit 29. In the present example, in accordance with the rotational angle θ and the rotation speed V of the rotary body 9 based on the determination results of both the speed determination unit 29 and the angle determination unit 30, the element selection unit 31 selects one(s) that are activated from the light emitting element 21.

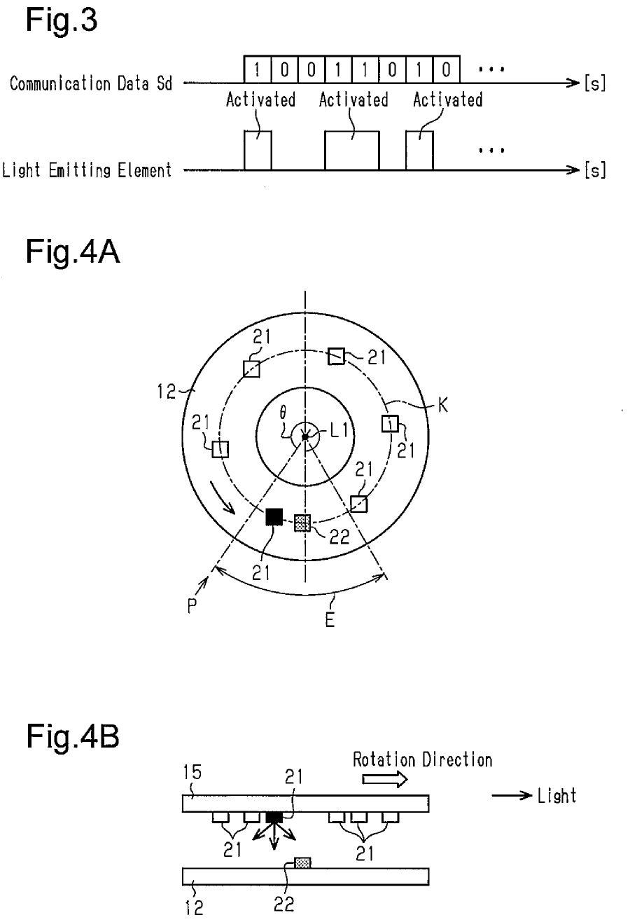

The operation and advantages of the rotary connector 1 will now be described with reference to FIGS. 3 to 6B.

As illustrated in FIG. 3, for example, when the detection unit 4 detects various operations in the steering wheel, the output processing unit 25 transmits the communication data Sd of a binary code corresponding to the output signal Sout received from the detection unit 4 toward the fixed body 8 through optical communication. In the present example, the output processing unit 25 turns on a light emitting element 21, for example, when binary information corresponding to one is output, and turns off the light emitting element 21 when binary information corresponding to zero is output. In this manner, the output processing unit 25 obtains the communication data Sd of binary information through the turning on/off of the light emitting element 21 and transmits the communication data Sd toward the fixed body 8.

As illustrated in FIGS. 4A and 4B, when the rotary body 9 is rotating and a light emitting element 21 reaches an activation start point P, which is set on the movement path K in accordance with the rotation speed V of the rotary body 9, the element selection unit 31 activates the light emitting element 21 at this point in time. The activation start point P corresponds to the rotational angle θ of the light emitting elements 21 with reference to the light receiving element 22. In the present example, the position of the light receiving element 22 in a rotation direction (direction of arrow R in FIG. 1) of the rotary body 9 is defined as an angle measurement start point, and the rotational angle θ has a value that chances and increases from 0° to 360° in accordance with separation from the angle measurement start point (rotation in counterclockwise direction in FIG. 4A).

As described above, the activation start point P is set for the light emitting elements 21 in accordance with the rotation speed V of the rotary body 9. When the rotary body 9 is rotating, one of the light emitting elements 21 is activated at the time when the light emitting element 21 is located at the rotational angle θ determined by the angle determination unit 30. The light emitting elements 21 are sequentially activated when reaching the activation start point P. When a range in the rotation direction (direction of arrow R in FIG. 1) of the rotary body 9 where the light emitting elements 21 are activated is referred to as a activation range E (illumination range), the activation range E is set to be wider as the rotation speed V increases, and the activation range E is set to be narrower as the rotation speed V decreases. The activation range E is set so that the light receiving element 22 is located in the activation range E. After a light emitting element 21 is activated, or turned on, it is preferred that the element selection unit 31 deactivate, or turn off, the activated light emitting element 21 when the activated light emitting element 21 is separated from the light receiving element 22 by a predetermined amount (e.g., approximately 45° from light receiving element 22).

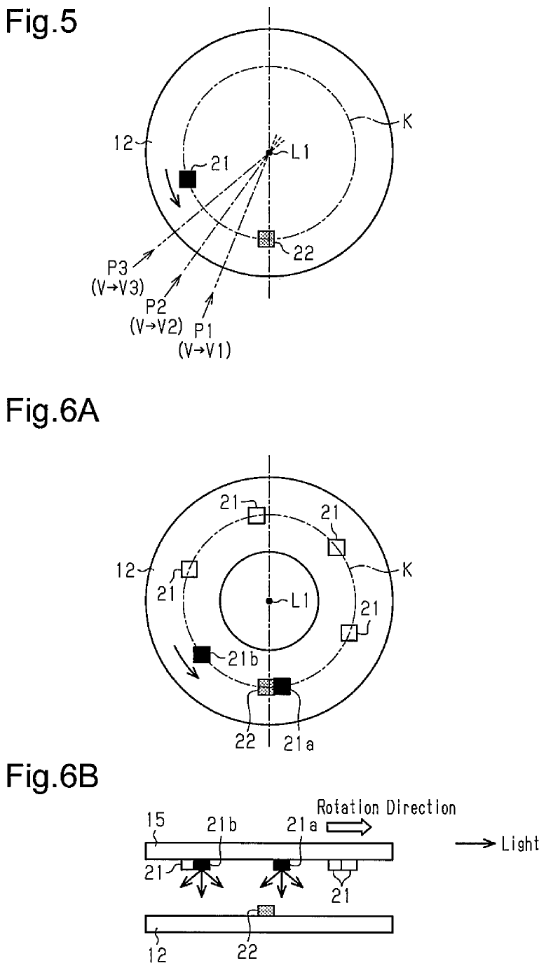

As illustrated in FIG. 5, the activation start point P is set on the movement path K in accordance with the rotation speed V of the rotary body 9. More specifically, when the rotation speed V is a relatively low speed V1, the activation start point P is set at a point P1 that is close to the light receiving element 22. When the rotation speed V is a speed V2 that is higher than the speed V1, the activation start point P is set at a point P2 that is farther from the light receiving element 22 than the point P1. When the rotation speed V is a speed V3 that is higher than the speed V2, the activation start point P is set at a point P3 that is even farther from the light receiving element 22. Thus, as the rotation speed V of the rotary body 9 increases, the point in time for starting to activate the light emitting elements 21 is advanced.

As illustrated in FIG. 5, when the rotary body 9 rotates at a high speed, the activation start point P is set at a position distant from the light receiving element 22. Thus, as illustrated in FIGS. 6A and 6B, when the rotary body 9 rotates at a high speed, not only a light emitting element 21a that is closest to the light receiving element 22 is switched to the activation state, but the next light emitting element 21b is also switched to the activation state in advance. That is, the multiple light emitting elements 21 are simultaneously activated. This limits discontinuity of the light from the light emitting elements 21 and improves the stability of optical communication.

Even if the rotation speed of the rotary body 9 changes during the rotation, it is preferred that the activation range E (illumination range), in other words, the turning-off point in time, that is once set for the light emitting elements 21 remain the same. This is because the process will be complicated if the point in time for turning off the light emitting elements 21 is variable in accordance with a change in speed.

In the present example, when communication is performed between the fixed body 8 and the rotary body 9 through optical communication using the light emitting elements 21 and the light receiving element 22, the rotation speed V of the rotary body 9 is obtained, and the light emitting elements 21 are activated at points in time corresponding to the rotation speed V. Thus, all of the light emitting elements 21 are not constantly activated in optical communication. Instead, an appropriate one is selected in accordance with the rotation speed V of the rotary body 9. This reduces power consumption and improves power saving in the rotary connector 1 of an optical communication type.

The element selection unit 31 selects light emitting element(s) 21 that are activated using the rotation speed V and the rotational angle θ as parameters. That is, the angle detection signal Sθ of the angle detection unit 18 is used to obtain the rotation speed V and the rotational angle θ of the rotary body 9, and light emitting element(s) 21 that are activated are selected in accordance with the rotation speed V and the rotational angle θ. As described above, in the present example, in addition to the rotation speed V, the rotational angle θ is used to determine when to illuminate the light emitting elements 21. Thus, the light emitting elements 21 are activated at the optimal point in time in accordance with the condition. This is advantageous to improve the stability of communication establishment.

The rotational angle θ is defined as an angle of a light emitting element 21 in the rotation direction (direction of arrow R in FIG. 1) of the rotary body 9. The element selection unit 31 activates the light emitting element 21 at a point in time when the rotational angle θ reaches the activation start point P. The element selection unit 31 changes the activation start point P in accordance with the rotation speed V to change the point in time for activating the light emitting element 21. As a result, the activation of the light emitting elements 21 is optimized through a simple process that changes the activation start point P of the light emitting elements 21 in accordance with the rotation speed V of the rotary body 9. This is further advantageous to increase the stability of communication establishment.

The range in the rotation direction (direction of arrow R in FIG. 1) of the rotary body 9 where the light emitting element(s) 21 are activated is defined as the activation range E. The element selection unit 31 sets the activation range E to be wider as the rotation speed V increases and sets the activation range E to be narrower as the rotation speed V decreases. Thus, as the rotation speed V of the rotary body 9 is increased, the activation range E of the light emitting elements 21 is set to be wider, accordingly. Even when the rotary body 9 rotates quickly, the light from the light emitting elements 21 consistently strikes the light receiving element 22.

The embodiment is not limited to the configurations described above and may be modified as follows.

The binary information may be set to, for example, zero when the light is turned on, and one when the light is turned off.

The light emitting elements 21 may be arranged on the fixed body 8. The light receiving element 22 may be arranged on the rotary body 9.

The arrangement of the light emitting elements 21 is not limited to the equal interval arrangement and may be any arrangement.

Members other than LEDs may be used as the light emitting elements 21.

The arrangement of the light emitting elements 21 and the light receiving element 22 are not limited to being disposed on the substrates 12 and 15 and may be any position of the fixed body 8 and the rotary body 9.

The angle determination unit 30 is not limited to using the angle detection unit 18 such as a steering angle sensor and may be any member that is capable of detecting a rotation amount of the rotary body 9.

When the light emitting elements 21 are selectively activated, the pattern of the embodiment for turning on the light emitting elements 21 may be changed to a different pattern.

The path of communication establishes a data line. Instead, the path of communication may establish, for example, a control line or a power line.

Only the rotation speed V may be used as a parameter to set a point in time of activating the light emitting elements 21. In this case, for example, when the rotation speed V is high, activation is sequentially switched between the light emitting elements 21 at short intervals. When the rotation speed V is low, activation is sequentially switched between the light emitting elements 21 at long intervals.

The communication data Sd is not limited to the multiplexing signal and may be data obtained from output of a single detection unit 4.

The amount of light of the light emitting elements 21 may be changed in accordance with the rotation speed V of the rotary body 9.

The rotation speed V of the rotary body 9 includes acceleration.

The rotary connector 1 is not limited to use in a vehicle and may be used in other devices or apparatus.

1. A rotary connector comprising:
a fixed body;
a rotary body, wherein one of the fixed body and the rotary body includes a plurality of light emitting elements, the other of the fixed body and the rotary body includes a light receiving element, and the rotary connector allows optical communication between the light emitting elements and the light receiving element to allow communication between the fixed body and the rotary body when rotation of the rotary body is allowed;
a speed determination unit that determines a rotation speed of the rotary body; and
an element selection unit that selects a light emitting element that is activated from the light emitting elements based on a determination result of the speed determination unit.

2. The rotary connector according to claim 1, further comprising an angle determination unit that determines a rotation angle of the rotary body,
wherein the element selection unit uses the rotation speed and the rotation angle as parameters to select the light emitting element that is activated.

3. The rotary connector according to claim 2, wherein
the rotation angle is an angle of the light emitting element in a rotation direction of the rotary body,
the element selection unit activates the light emitting element at a point in time when the rotation angle reaches an activation start point, and
the element selection unit changes the activation start point in accordance with the rotation speed to change a point in time for activating the light emitting element.

4. The rotary connector according to claim 2, wherein
a range in a rotation direction of the rotary body where the light emitting element is activated is sets as an activation range, and
the element selection unit sets the activation range to be wider as the rotation speed increases and sets the activation range to be narrower as the rotation speed decreases.

5. The rotary connector according to claim 1, wherein a maximum number of the light emitting elements that are simultaneously activated is two.
